(19) United States
(12) Patent Application Publication
(10) Pub. No.: US 2018/0159098 A1
(43) Pub. Date: Jun. 7, 2018

(54) LITHIUM-ION BATTERY PACK

(71) Applicant: Trippe Manufacturing Company, Chicago, IL (US)

(72) Inventors: Salim Ling, Buffalo Grove, IL (US); Richard Steegmueller, Morton Grove, IL (US); Paul Dickerson, Oak Park, IL (US); Dan Bean, Downers Grove, IL (US); Yong Chen, Chicago, IL (US); Kevin Lacey, Oak Park, IL (US); Cristian Barrero, Chicago, IL (US)

(21) Appl. No.: 15/368,150

(22) Filed: Dec. 2, 2016

(51) Int. Cl. H01M 2/10; H01M 10/0525; H01M 10/42; H01M 2/20

(52) U.S. Cl. CPC H01M 2/1077; H01M 10/0525; H01M 2010/4271; H01M 2/202; H01M 10/4257

(57) ABSTRACT

A lithium-ion battery pack includes a housing, a plurality of lithium-ion cells, a first bus bar, a second bus bar, and an interconnect plate. The control circuit includes a printed circuit board that has a longitudinal axis. Each of the cells has a longitudinal axis that is positioned parallel to a longitudinal axis of the printed circuit board. The plurality of cells are all arranged in at least a first cell stack and a second cell stack. The first bus bar electrically couples the printed circuit board to cell terminals of the first cell stack that are adjacent to the first sidewall. The second bus bar electrically couples the printed circuit board to cell terminals of the second cell stack that are adjacent to the first sidewall. The interconnect plate electrically couples the cell terminals of the plurality of lithium-ion cells positioned adjacent to the second sidewall.

### BACKGROUND

The battery packs as described below are for replacement of sealed lead acid (“SLA”) battery packs in applications such as uninterruptible power supplies (“UPSs”) and motor vehicles.

For years, applications such as UPSs have used sealed lead acid (“SLA”) battery packs. In recent years, lithium-ion battery technology has made many advances in terms of cost and functionality. Lithium-ion batteries have several advantages over SLA batteries. Lithium-ion batteries weigh significantly less, are more efficient, have a shorter charging time, and have a longer cycle life than SLA batteries. However, using lithium-ion batteries as a direct substitute for SLA batteries in a standard form factor presents several challenges.

For example, designing a lithium-ion battery pack that has the same approximate outer dimensions as an SLA battery pack, ensuring compliance with the standards required for such a battery pack, and having a high power output are each difficult. Current lithium-ion battery packs sometimes sacrifice power output to meet space limitations, thermal limitations, and electrical requirements. A more advanced lithium-ion battery pack is needed to maximize lithium-ion batteries' characteristics.

On the mechanical side, it is challenging to assemble a large number of cells into a battery pack while under space constraint, and do it in a way that is economical, easy to assemble, and dissipates heat effectively. Complex cell connection patterns and welding methods have to be created to minimize the potential for assembly errors that can result in lowered capacity and field failures. The higher the cell count in the in the battery pack, the higher the manufacturing risk. All of these challenges complicate the task of constructing a useful, cost-efficient lithium-ion battery pack.

### SUMMARY

In a first embodiment, a lithium-ion battery pack includes a housing, a first battery pack terminal, a second battery pack terminal, a control circuit, a plurality of lithium-ion cells, a first bus bar, a second bus bar, and an interconnect plate. The housing includes a top, a base, a first sidewall, and a second sidewall. The second sidewall is opposite from the first sidewall. The control circuit is within the housing. The control circuit includes a printed circuit board that has a longitudinal axis. The plurality of lithium-ion cells are within the housing. Each of the plurality of lithium-ion cells includes two cell terminals and a longitudinal axis that is positioned parallel with the longitudinal axis of the printed circuit board. The plurality of lithium-ion cells are all arranged in at least a first cell stack and a second cell stack. The first and second bus bars extend substantially from the base to the top of the housing. The first bus bar electrically couples the printed circuit board to cell terminals of the first cell stack. The cell terminals of the first cell stack are adjacent to the first sidewall. The second bus bar electrically couples the printed circuit board to cell terminals of the second cell stack. The cell terminals of the second cell stack are adjacent to the first sidewall. The interconnect plate electrically couples the cell terminals of the plurality of lithium-ion cells that are positioned adjacent to the second sidewall.

In another embodiment, a lithium-ion battery pack includes a housing, a first battery pack terminal, a second battery pack terminal, a control circuit, an interconnect plate, a first lithium-ion cell, and a second lithium-ion cell. The control circuit is within the housing. The control circuit includes a printed circuit board that has a longitudinal axis. The interconnect plate includes a bend between a first end and a second end of the interconnect plate. The interconnect plate also includes a first welding point on the first end of the interconnect plate and a second welding point on the second end of the interconnect plate. The first lithium-ion cell is coupled to the first welding point and to the first battery pack terminal. The second lithium-ion cell is coupled to the second welding point and to the second battery pack terminal. Each of the first lithium-ion cell and the second lithium-ion cell have a longitudinal axis that is positioned parallel with the longitudinal axis of the printed circuit board.

In another embodiment, a lithium-ion battery pack includes a housing, a first battery pack terminal, a second battery pack terminal, a control circuit, and a plurality of lithium-ion cells. The housing includes a top, a base, a first sidewall, a second sidewall, a third sidewall, a fourth sidewall, and a plurality of vents. A first distance between the top and the base is approximately 94 millimeters. A second distance between the first sidewall and the second sidewall is approximately 150 millimeters. A third distance between the third sidewall and the fourth sidewall is approximately 65 millimeters. The plurality of vents constitute at least five percent of a surface area of the housing. The control circuit is within the housing. The plurality of lithium-ion cells are within the housing. The plurality of lithium-ion cells are electrically coupled to the first battery pack terminal and to the second battery pack terminal.

In another embodiment, a lithium-ion battery pack includes a housing, a first battery pack terminal, a second battery pack terminal, a control circuit, a plurality of lithium-ion cells, and an externally exposed heat sink. The housing defines an interior space. The control circuit is within the housing. The control circuit includes a printed circuit board. The plurality of lithium-ion cells are within the housing. The externally exposed heat sink is thermally coupled to the interior space.

In another embodiment, a lithium-ion battery pack includes a housing, a first battery pack terminal, a second battery pack terminal, a control circuit, a plurality of lithium-ion cells, and an bus bar. The control circuit is within the housing. The plurality of lithium-ion cells are within the housing. The bus bar electrically couples the plurality of lithium-ion cells to the control circuit. The bus bar includes a first metal layer and a second metal layer. The first metal layer includes a plurality of welding points for connection to cell terminals of the plurality of lithium-ion cells. The first metal layer is composed substantially of nickel. The second metal layer is coupled to the first metal layer. The second metal layer is composed of a high conductivity metal other than nickel.

In another embodiment, a lithium-ion battery pack includes a housing, a first battery pack terminal, a second battery pack terminal, a plurality of lithium-ion cells, and a control circuit. The plurality of lithium-ion cells are within the housing. The control circuit is within the housing. The control circuit includes a battery bypass circuit. The battery bypass circuit is configured to selectively allow electrical current to flow directly between the first battery pack terminal and the second battery pack terminal.

In another embodiment, a lithium-ion battery pack includes a housing, a first battery pack terminal, a second battery pack terminal, a plurality of lithium-ion cells, and a bus bar. The housing includes a top. The plurality of lithium-ion cells are within the housing. Each of the plurality of lithium-ion cells includes a longitudinal axis that is positioned parallel with the top. The plurality of lithium-ion cells are all arranged in at least a first cell stack. The first cell stack includes a first lithium-ion cell and a second lithium-ion cell. The bus bar includes a first metal layer and a second metal layer. The first metal layer includes a first welding point that is coupled to a first terminal of the first lithium-ion cell. The first metal layer also includes a second welding point that is coupled to a first terminal of the second lithium-ion cell. The first metal layer is electrically coupled to the first battery pack terminal. The second metal is composed of metal different than the first metal layer. The second metal layer includes a first aperture that is positioned adjacent to the first welding point. The second metal layer also includes a second aperture that is positioned adjacent to the second welding point.

In another embodiment, a lithium-ion battery pack includes a housing, a first battery pack terminal, a second battery pack terminal, a control circuit, a plurality of lithium-ion cells, and a spacer. The first battery pack terminal and the second battery pack terminal are partially within the housing. The control circuit is within the housing. The plurality of lithium-ion cells are within the housing. The plurality of lithium-ion cells are electrically coupled to the first battery pack terminal and to the second battery pack terminal. The spacer projects from either the top or the base. The spacer includes a stepped structure that is adapted to engage at least one selected from a group consisting of another battery pack housing, a recess in another battery pack housing, and another spacer.

Other aspects of the lithium-ion battery pack will become apparent by consideration of the detailed description and accompanying drawings.

### BRIEF DESCRIPTION OF THE DRAWINGS

FIGS. 1A and 1B are different perspective views of a housing of a lithium-ion battery pack, in accordance with some embodiments.

FIGS. 2A through 2C are different perspective views of the internal construction of a lithium-ion battery pack, in accordance with some embodiments.

FIGS. 3A through 3C are different side views of a bus bar included in a lithium-ion battery pack, in accordance with some embodiments.

FIG. 4A through 4D illustrate a process for bending an interconnect plate included in a lithium-ion battery pack, in accordance with some embodiments.

FIG. 5A is a cross-sectional view of a lithium-ion battery pack, in accordance with some embodiments.

FIG. 5B is an enlarged view of a portion of FIG. SA.

FIGS. 6A and 6B are perspective views of a housing of a lithium-ion battery pack including spacers, in accordance with some embodiments.

FIG. 7 is a perspective view of a spacer included in FIG. 6A.

FIG. 8A is a top view of a housing of a lithium-ion battery pack including recesses, in accordance with some embodiments.

FIG. 8B is a bottom view of a housing of a lithium-ion battery pack including recesses, in accordance with some embodiments.

FIG. 9A is a side view of a nested array of two lithium-ion battery packs.

FIG. 9B is a side view of a non-nested array of two lithium-ion battery packs.

FIG. 9C is a side view of a series array of two lithium-ion battery packs.

FIG. 10 is a diagram of two lithium-ion battery packs connected in series with a battery pack charger, in accordance with some embodiments.

### DETAILED DESCRIPTION

Before any embodiments of the lithium-ion battery pack are explained in detail, it is to be understood that the lithium-ion battery pack is not limited in its application to the details of construction and the arrangement of components set forth in the following description or illustrated in the following drawings. The lithium-ion battery pack is capable of other embodiments and of being practiced or of being carried out in various ways.

It should also be noted that a plurality of different structural components may be utilized to implement the disclosure. Furthermore, and as described in subsequent paragraphs, the specific configurations illustrated in the drawings are intended to exemplify embodiments of the disclosure. Alternative configurations are possible.

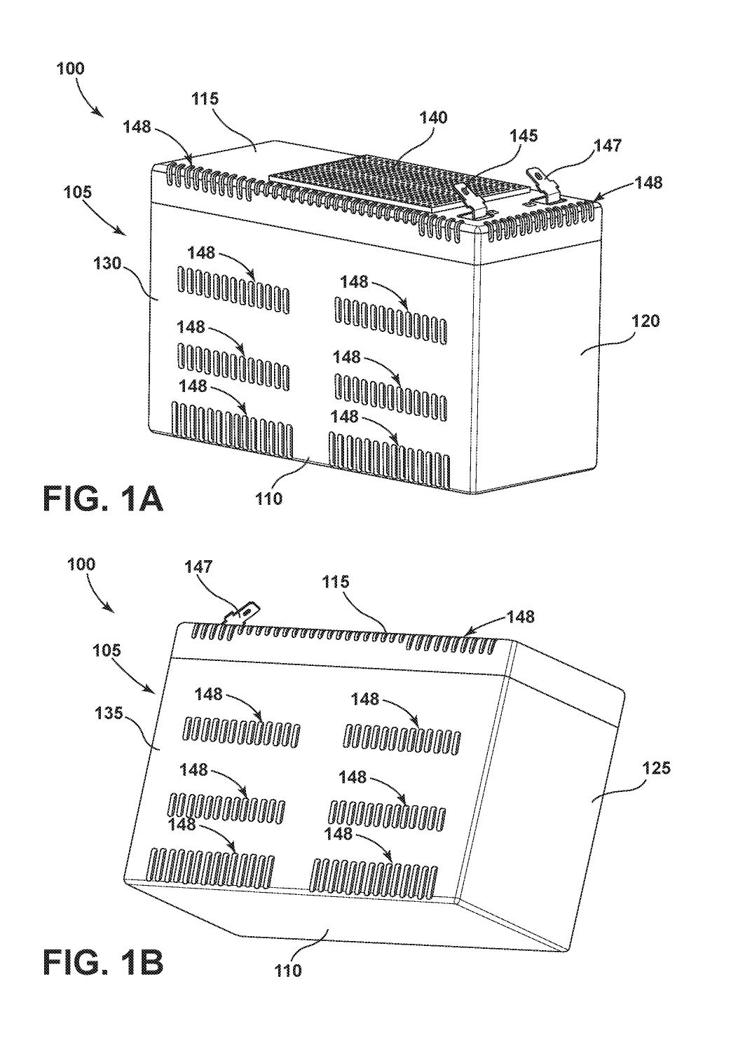

FIG. 1 is a perspective view of one exemplary embodiment of a lithium-ion battery pack 100 that includes a housing 105. The housing 105 illustrated in FIG. 1 can be used as a direct substitute of a standard form factor SLA 12 Volt/9 Amp battery pack. The housing 105 is generally rectangular in cross section and includes a base 110, a top 115, a first sidewall 120, a second sidewall 125 that is parallel to and opposite from the first sidewall 120, a third sidewall 130 that is perpendicular to the first sidewall 120, and a fourth sidewall 135 that is parallel to and opposite from the third sidewall 130. In some embodiments, the distance between the base 110 and the top 115 is approximately 94 millimeters. In some embodiments, the distance between the first sidewall 120 and the second sidewall 125 is approximately 150 millimeters. In some embodiments, the distance between the third sidewall 130 and the fourth sidewall 135 is approximately 65 millimeters. The top 115 of the housing 105 includes an externally exposed heat sink 140, which will be described in greater detail below. A first battery pack terminal 145 and a second battery pack terminal 147 extend upward from the top 115 of the housing 105. The housing 105 further includes rows of vents 148 disposed around the housing 105. The rows of vents 148 permit airflow through the housing 105. In some embodiments, the rows of vents 148 constitute between 5 and 25 percent of the surface area of the housing 105.

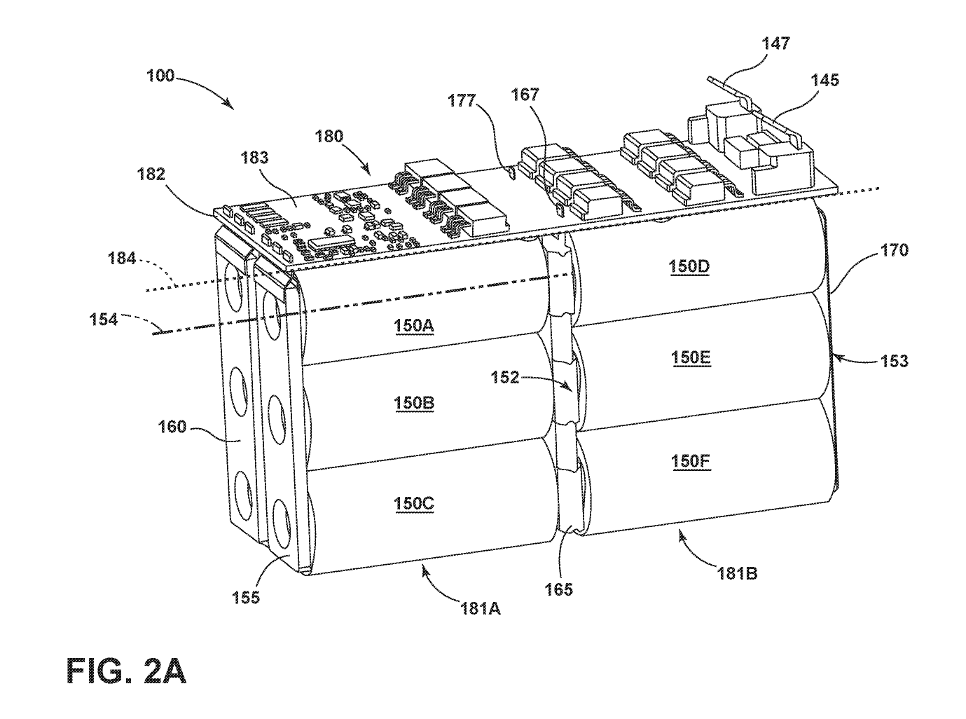

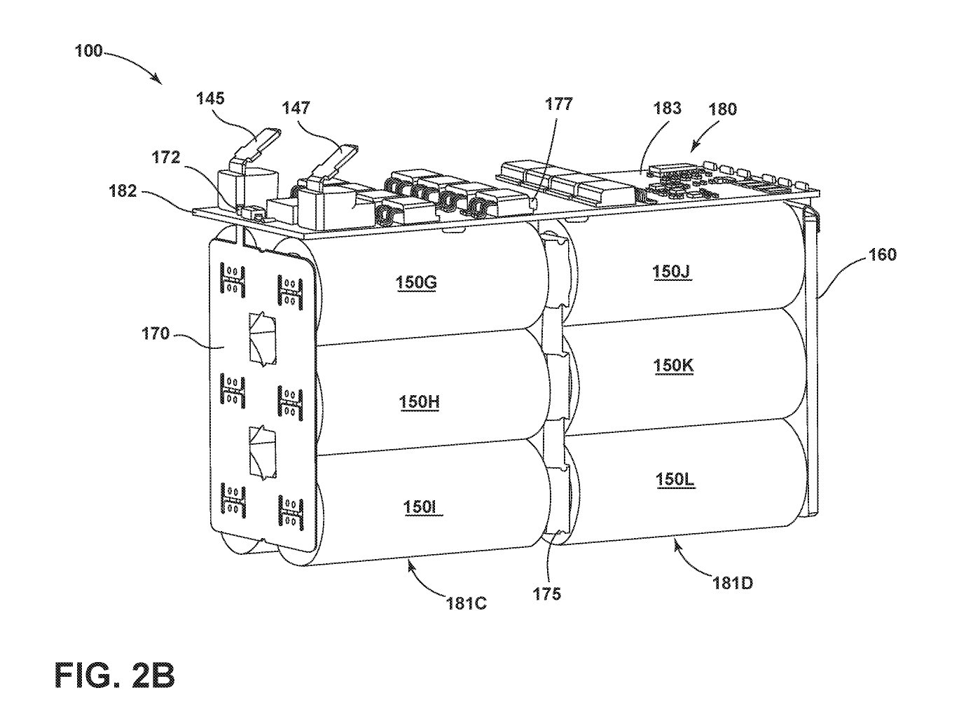

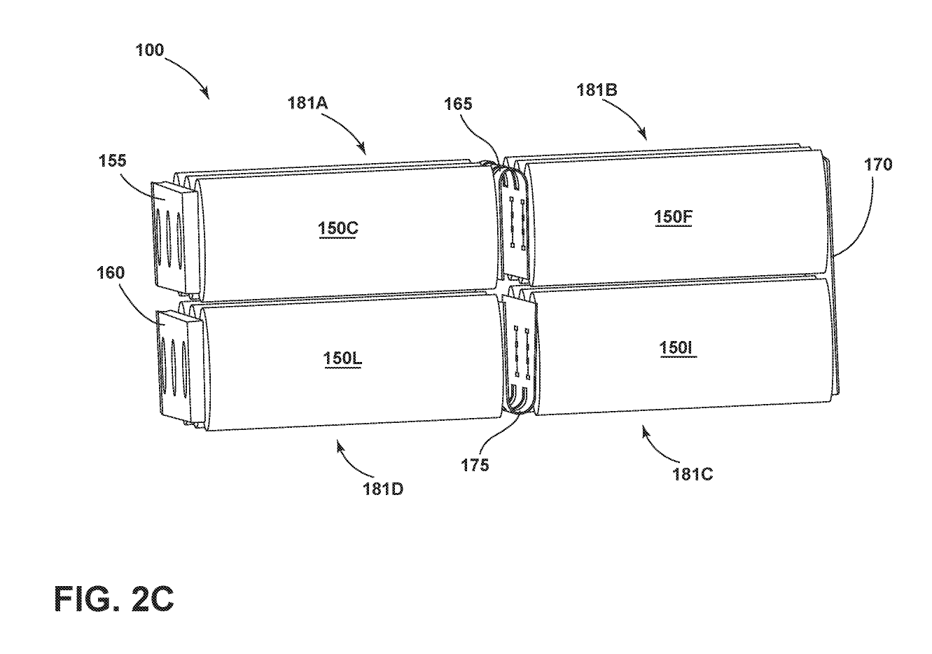

FIGS. 2A through 2C are diagrams illustrating different views of the internal construction of the lithium-ion battery pack 100. The lithium-ion battery pack 100 illustrated in FIGS. 2A through 2C includes within the housing 105 twelve lithium-ion cylindrical cells (hereinafter “the cells”) 150A though 150L (for example, 26650 or 18650 cylindrical cells), a first bus bar 155, a second bus bar 160, a first interconnect plate 165, a second interconnect plate 170, a third interconnect plate 175, and a control circuit 180. In some embodiments, the lithium-ion battery pack 100 includes a different type, shape, or quantity of lithium-ion cells, such as, prismatic cells.

Each of the twelve cells 150A through 150L illustrated in FIGS. 2A through 2C has a jelly roll structure of cylindrical shape. Each of the twelve cells 150A through 150L also includes a first cell terminal (for example, a positive terminal, a high voltage potential terminal) and a second cell terminal (for example, a negative terminal, a low voltage potential terminal). The second cell terminal is positioned on the opposite side from the first cell terminal. For example, the fourth cell 150E includes a first cell terminal 152 and a second cell terminal 153, as illustrated in FIG. 2A. The twelve cells 150A through 150L each include a longitudinal axis that is positioned parallel with the base 110 and the top 115 of the housing 105. For example, the first cell 150A includes a longitudinal axis 154 that is positioned parallel with the base 110 and the top 115 of the housing 105, as illustrated in FIG. 2A. The rows of vents 148, discussed above in relation to FIGS. 1A and 1B, are positioned parallel with the longitudinal axis of the twelve cells 150A through 150L.

The cells 150A through 150L are all arranged in four cell stacks 181A through 181C. Each cell stack includes at least two cells positioned such that the cells' longitudinal axes are parallel with each other. The twelve cells 150A through 150L are arranged in a three parallel and four series configuration as discussed in further detail below.

As illustrated in FIG. 2A, the first cell stack 181A includes the first, second, and third cells 150A through 150C. The first, second, and third cells 150A through 150C are coupled in parallel with each other. The first cell terminals of the first, second, and third cells 150A through 150C are adjacent to the first sidewall 120 and are coupled to the control circuit 180 via the first bus bar 155. The first bus bar 155 is also adjacent to the first sidewall 120 and extends substantially from the base 110 to the top 115 of the housing 105. The second cell terminals of the first, second, and third cells 150A through 150C are coupled to the first interconnect plate 165. The first interconnect plate 165 includes a voltage sensing point 167 (for example, a prong) which extends upward from the first interconnect plate 165 and is directly coupled (for example, soldered) to the control circuit 180 with no wires. This direct connection improves manufacturing efficiency and reliability.

Also, as illustrated in FIG. 2A, the second cell stack 181B includes the fourth, fifth, and sixth cells 150D through 150F. The fourth, fifth, and sixth cells 150D through 150F are coupled in parallel with each other and in series with the first, second, and third cells 150A through 150C. The first cell terminals of the fourth, fifth, and sixth cells 150D through 150F are coupled to the first interconnect plate 165. The second cell terminals of the fourth, fifth, and sixth cells 150D through 150F are adjacent to the second sidewall 125 and are coupled to the second interconnect plate 170. The second interconnect plate 170 includes a voltage sensing point 172 which extends upward from the second interconnect plate 170 and is directly coupled to the control circuit 180 with no wires.

As illustrated in FIG. 2B, the third cell stack 181C includes the seventh, eighth, and ninth cells 150G through 150I. The seventh, eighth, and ninth cells 150G through 150I are coupled in parallel with each other and in series with the fourth, fifth, and sixth cells 150D through 150F. The first cell terminals of the seventh, eighth, and ninth cells 150G through 150I are adjacent to the second sidewall 125 and are coupled to the second interconnect plate 170. The second cell terminals of the seventh, eighth, and ninth cells 150G through 150I are coupled to the third interconnect plate 175. The third interconnect plate 175 includes a voltage sensing point 177 which extends upward from the third interconnect plate 175 and is directly coupled to the control circuit 180 with no wires.

Also, as illustrated in FIG. 2B, the fourth cell stack 181D includes the tenth, eleventh, and twelfth cells 150J through 150L. The tenth, eleventh, and twelfth cells 150J through 150L are coupled in parallel with each other and in series with the seventh, eighth, and ninth cells 150G through 150I. The first cell terminals of the tenth, eleventh, and twelfth cells 150J through 150L are coupled to the third interconnect plate 175. The second cell terminals of the tenth, eleventh, and twelfth cells 150J through 150L are adjacent to the first sidewall 120 and are coupled to the control circuit 180 via the second bus bar 160. The second bus bar 160 is side-by-side with the first bus bar 155 and is also adjacent to the first sidewall 120 and extends substantially from the base 110 to the top 115 of the housing 105.

As best shown in FIGS. 2A and 2B, the control circuit 180 includes a printed circuit board (“PCB”) 182 that defines at least one planar surface 183 populated with a plurality of electrical and electronic components that provide power, operational control, and protection to the lithium-ion battery pack 100. The PCB 182 also includes, among other components, a plurality of additional passive and active components such as field effect transistors (“FETs”), resistors, capacitors, inductors, integrated circuits, and amplifiers. These components are arranged and connected to provide a plurality of electrical functions to the PCB 182 including, among other things, filtering, signal conditioning, or voltage regulation. The PCB 182 includes a longitudinal axis 184 that is positioned parallel to the longitudinal axes of the cells 150A through 150L. For example, longitudinal axis 184 of the PCB 182 is positioned parallel to the longitudinal axis 154 of the first cell 150A.

Current (i.e., electrical current) flows from one end of the printed circuit board 182 through the cells 150A through 150L to the other end of the printed circuit board 182. More specifically, the current flows from the second battery pack terminal 147 to the second bus bar 160 via a plurality of fuses, FETs, and shunt resistors included in the printed circuit board 182. The current flows through the second bus bar 160 to the tenth, eleventh, and twelfth cells 150J through 105L. Next, the current flows through the third interconnect plate 175 to the seventh, eighth, and ninth cells 150G through 150I. The current then flows through the second interconnect plate 170 to the fourth, fifth, and sixth cells 150D through 150F. Next, the current flows through the first interconnect plate 165 to the first, second, and third cells 150A through 150C. The current then flows through the first bus bar 155 and the printed circuit board 182 to the first battery pack terminal 145.

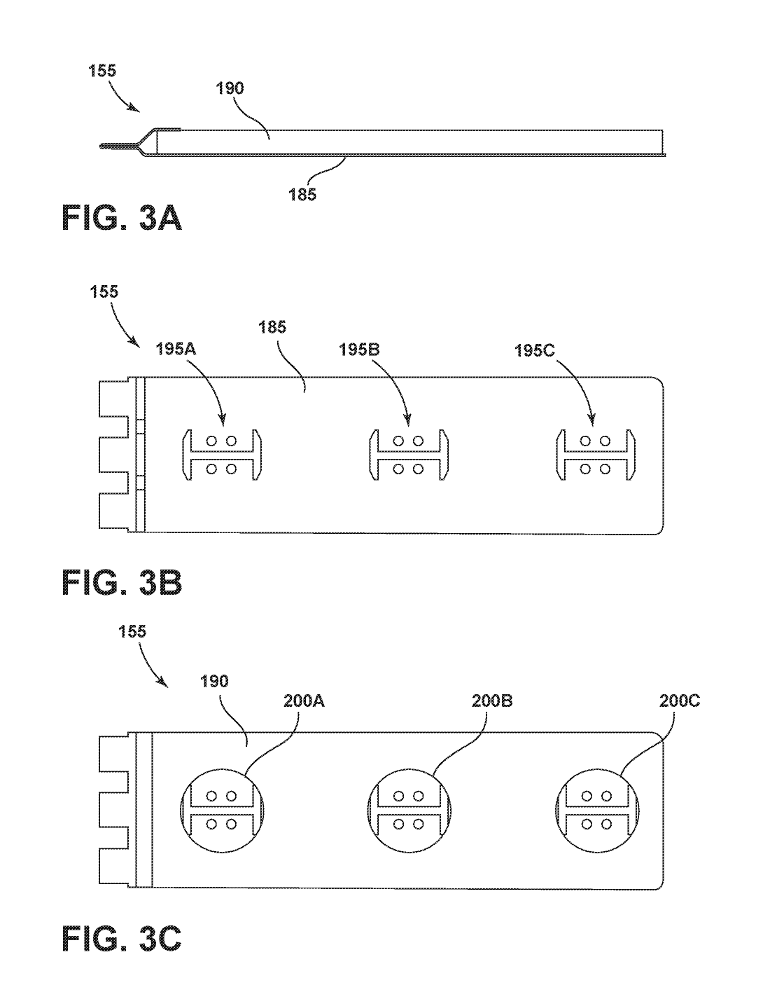

FIGS. 3A through 3C are diagrams of one exemplary embodiment of the first bus bar 155. The first bus bar 155 includes a first metal layer 185 and a second metal layer 190. In some embodiments, the first metal layer 185 is comprised substantially of nickel (for example, a nickel alloy). In some embodiments, the second metal layer 190 is comprised of a high conductivity metal other than nickel, such as copper or aluminum. In some embodiments, the second metal layer 190 further includes a thin layer of nickel deposited on the high conductivity metal. The second metal layer 190 is coupled to the first metal layer 185 (for example, by welding). In the embodiment illustrated, the second metal layer 190 is thicker than the first metal layer 185. In some embodiments, the first metal layer 185 is approximately 0.25 millimeters thick and the second metal layer 190 is approximately 3 millimeters thick.

As illustrated in FIG. 3B, the first metal layer 185 includes three welding points 195A through 195C for the first, second, and third cells 150A through 150C. For example, the first cell terminal of the first cell 150A is spot-welded to welding point 195A. The second metal layer 190 ensures a low impedance connection between the first, second, and third cells 150A through 150C. The second metal layer 190 also aids in balancing the amount of current that flows through the cells connected in parallel. As illustrated in FIG. 3C, the second metal layer 190 includes three apertures 200A through 200C which facilitate spot-welding of the three welding points 195A through 195C to the first cell terminals of the first, second, and third cells 150A through 150C.

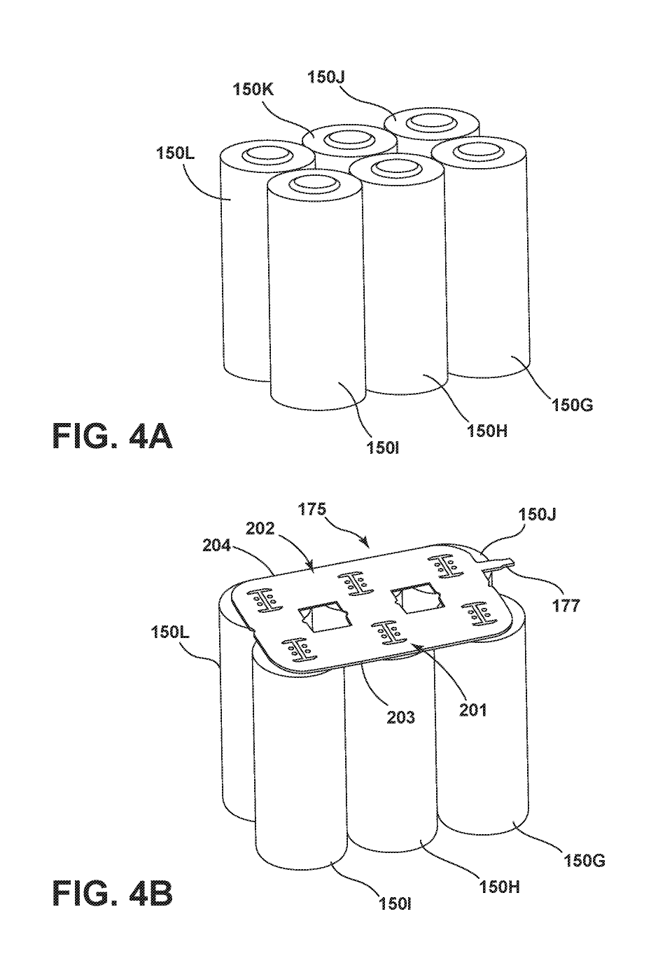

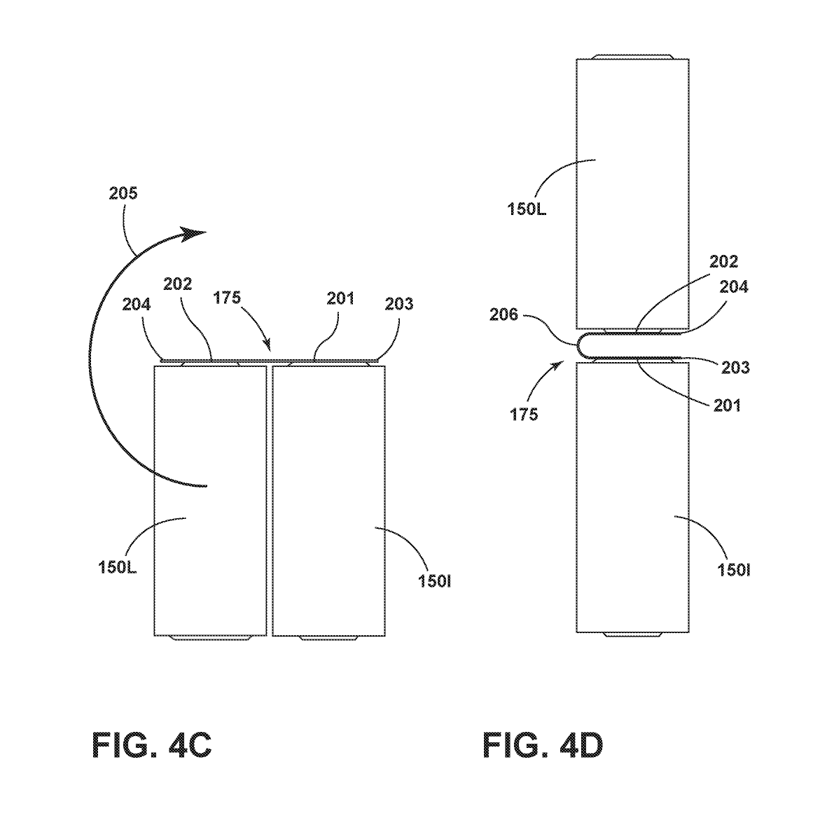

FIGS. 4A through 4D illustrate a process of folding the third interconnect plate 175. To start, the seventh, eighth, ninth, tenth, eleventh, and twelfth cells 150G thorough 150L are positioned in a two by three array configuration, as illustrated in FIG. 4A. The second cell terminals of the seventh, eighth, and ninth cells 150G through 150I are positioned parallel to the first cell terminals of the tenth, eleventh, and twelfth cells 150I through 150L. As illustrated in FIG. 4B, the third interconnect plate 175 includes a first plurality of welding points 201 and a second plurality of welding points 202. The first plurality of welding points 202 are positioned on a first end 203 of the third interconnect plate 175. The second plurality of welding points 202 are positioned on a second end 204 of the third interconnect plate 175. The second cell terminals of the seventh, eighth, and ninth cells 150G through 150I are spot-welded to the first plurality of welding points 201 on the third interconnect plate 175. The first cell terminals of the tenth, eleventh, and twelfth cells 150I through 150L are spot-welded to the second plurality of welding points 202 on the third interconnect plate 175. Next, as illustrated in FIG. 4C, the tenth, eleventh, and twelfth cells 150I through 150L are moved in the direction of arrow 205 until the third interconnect plate 175 is bent into a U-shape, as illustrated in FIG. 4D. In FIG. 4D, the third interconnect plate 175 includes a bend 206 between the first end 203 and the second end 204 of the third interconnect plate 175. Also, in FIG. 4D, the first plurality of welding points 201 are positioned opposite from the second plurality of welding points 202.

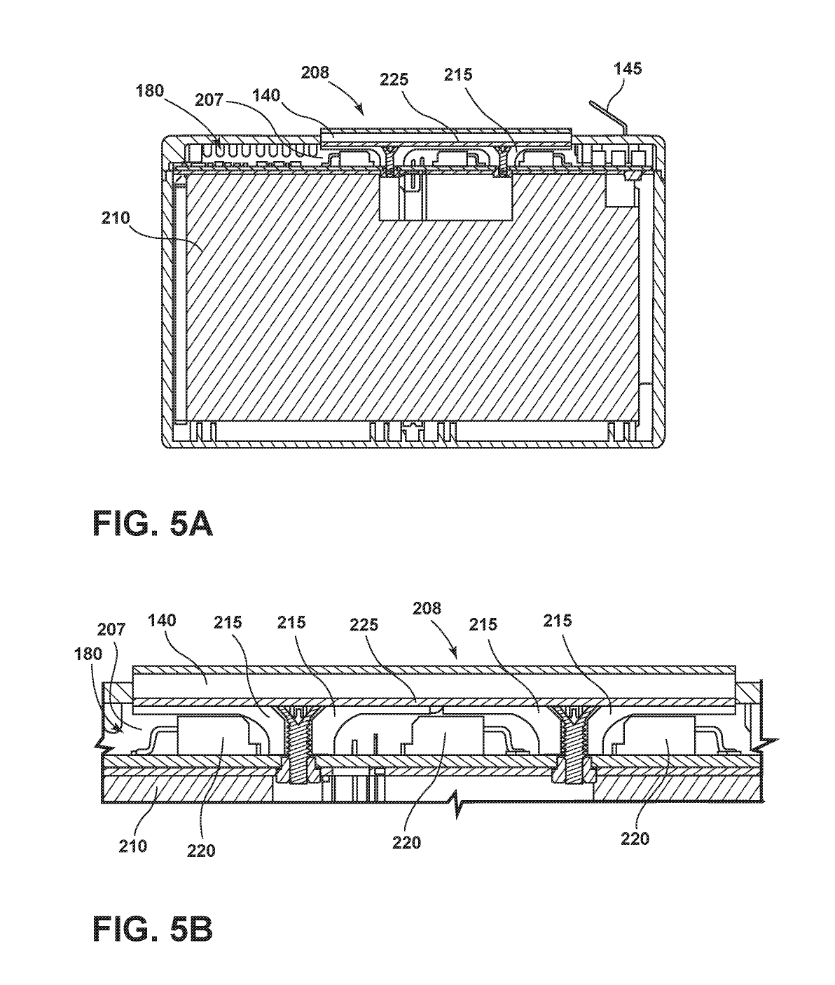

During operation, many of the components included in the control circuit 180 as well as the twelve cells 150A through 150L generate unwanted heat. FIG. 5A is a cross-sectional side view of an embodiment of the lithium-ion battery pack 100 which illustrates several heat sink components. At least a portion of the externally exposed heat sink 140 is outside of the housing 105. The externally exposed heat sink 140 is thermally coupled to an interior space 207 of the housing 105. The externally exposed heat sink 140 includes a plurality of fins 208 which extend at an angle relative to a remainder of the externally exposed heat sink 140. In some embodiments, the lithium-ion battery pack 100 includes an insulator layer 210 that is disposed between cells 150A through 150F and cells 150G through 150L. The insulator layer 210 is a structural element that provides stiffening to help during manufacturing. In some embodiments, the insulator layer 210 is comprised of a non-conductive plastic, a fiberglass material, or a glass-reinforced epoxy laminate sheet. The lithium-ion battery pack 100 also includes internal heat sinks 215 disposed within the interior space 207 of the housing 105. In some embodiments, the internal heat sinks 215 are comprised of aluminum. As illustrated in FIG. 5B, the internal heat sinks 215 are disposed above a plurality of FETs 220 included in the control circuit 180. The internal heat sinks 215 are thermally coupled to the externally exposed heat sink 140 via an isolator layer 225. In some embodiments, the isolator layer 225 is comprised of a silicone rubber with a high thermal conductivity. In addition to thermally coupling, the isolator layer 225 electrically isolates the internal heat sinks 215 and the externally exposed heat sink 140.

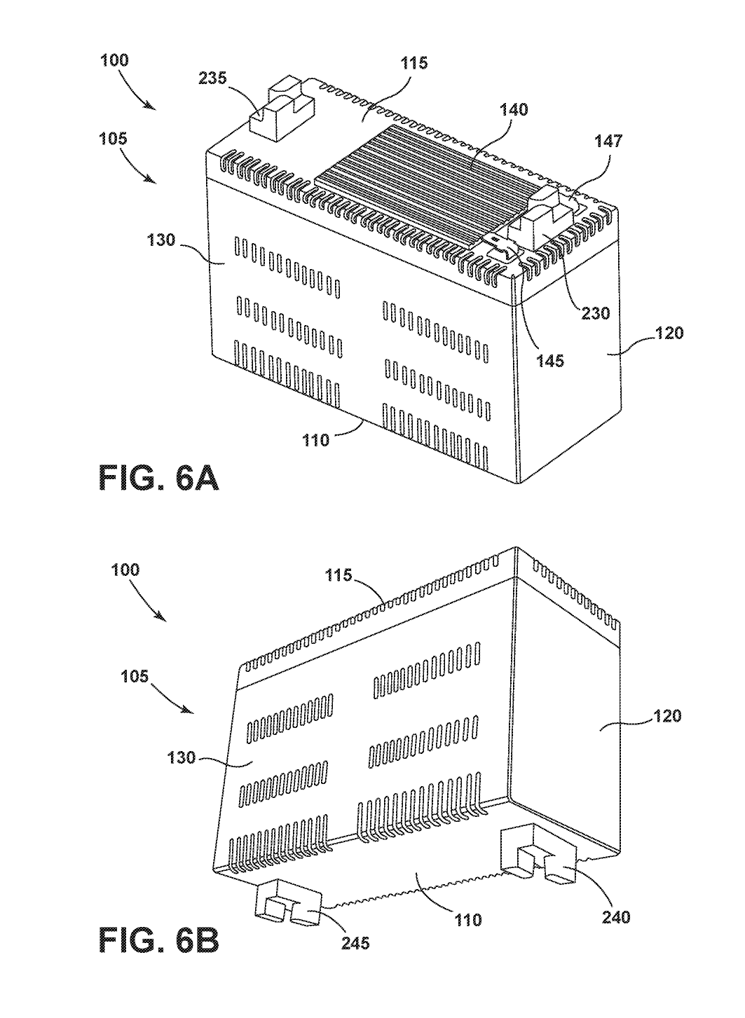

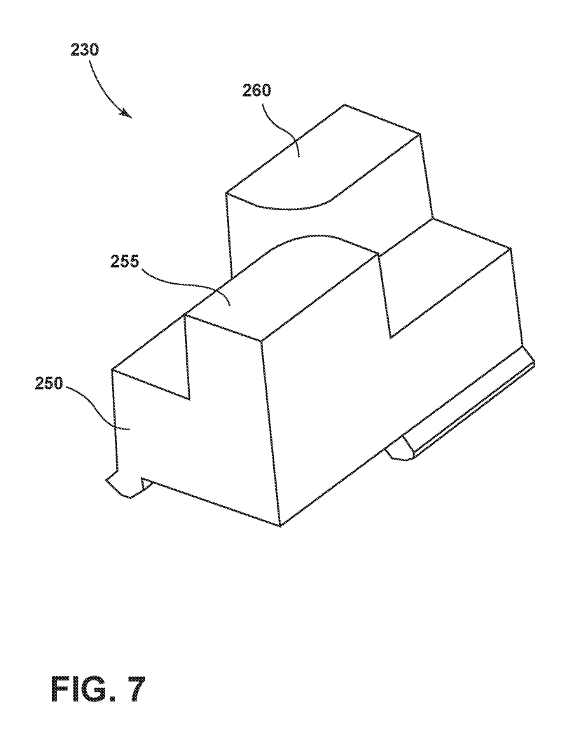

In some applications, and depending upon power needs, multiple lithium-ion battery packs are utilized together. FIG. 6A illustrates an embodiment of the housing 105 that includes two spacers 230 and 235 projecting from the top 115 of the housing 105. FIG. 6B illustrates an embodiment of the housing 105 that includes two spacers 240 and 245 projecting from the bottom 110 of the housing 105. In some embodiments, the spacers 230 through 245 are molded into the housing 105. FIG. 7 is an enlarged view of spacer 230 in FIG. 6A. Spacer 230 includes a stepped structure that is adapted to engage another battery pack housing, a recess in another battery pack housing, or another spacer. In some embodiments, as illustrated in FIG. 7, spacer 230 includes a first level 250, a first projection 255, and a second projection 260. The first level 250 extends from the housing 105. The first projection 255 and the second projection 260 extend further from the housing 105 than the first level 250.

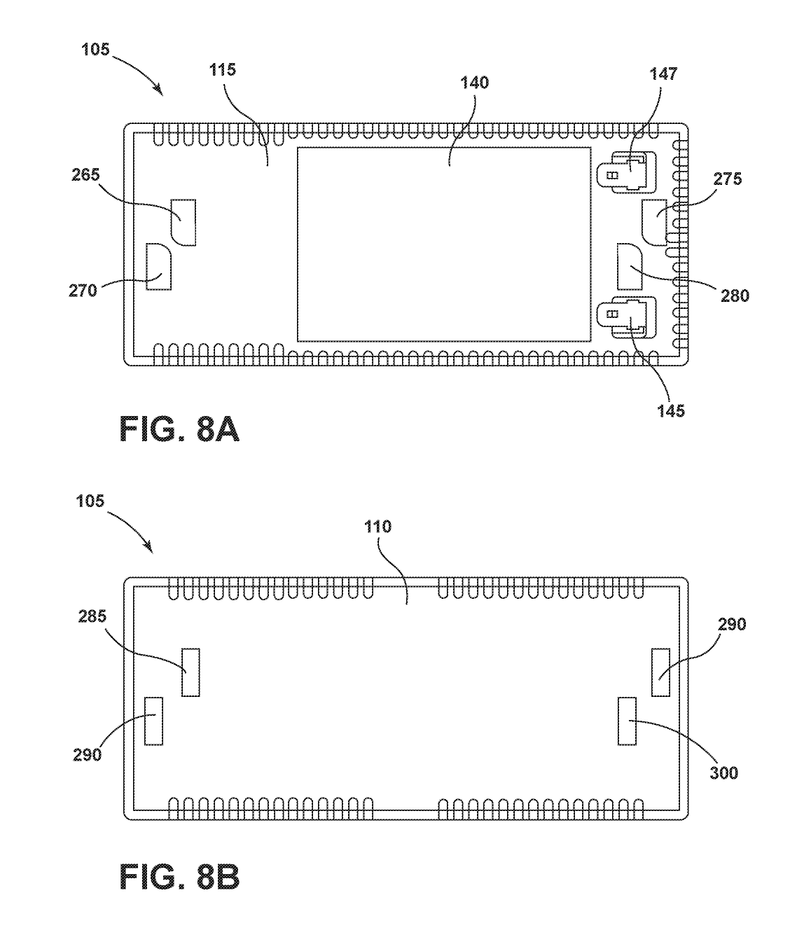

FIG. 8A illustrates an embodiment of the housing 105 that includes four recesses 265, 270, 275, and 280 on the top 115 of the housing 105. FIG. 8B illustrates an embodiment of the housing 105 that includes four recesses 285, 290, 295, and 300 on the base 110 of the housing 105. The recesses 265, 270, 275, 280, 285, 290, 295, and 300 are configured to receive and engage the spacers 230, 235, 240, and 245 so as to mount two battery packs in a stable position. In some embodiments, the housing 105 includes recesses on both the base 110 and the top 115 of the housing 105.

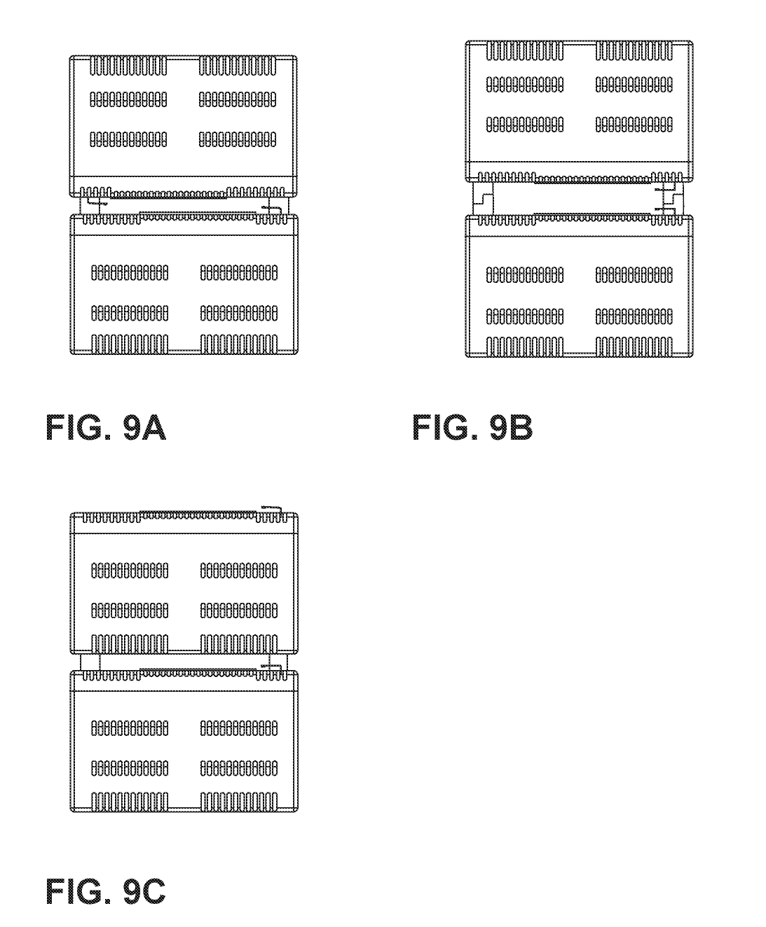

FIGS. 9A through 9C illustrate several different spacing configurations between two lithium-ion battery packs. In FIG. 9A, the tops of the two lithium-ion battery packs are positioned next to each other with a narrow amount of distance therebetween. Also, in FIG. 9A, the two lithium-ion battery packs are positioned such that the battery pack terminals of one of the lithium-ion battery packs are positioned opposite from the battery pack terminals of the other lithium-ion battery pack. Alternatively, the spacers may engage like spacers on a different lithium-ion battery pack to mount the two lithium-ion battery packs in a stable position. In FIG. 9B, the tops of the two lithium-ion battery packs are positioned next to each other with a wider amount of distance therebetween as compared to the configuration of FIG. 9A. Also, in FIG. 9B, the two lithium-ion battery packs are positioned such that the battery pack terminals of one of the two lithium-ion battery packs are positioned next to the battery pack terminals of the other lithium-ion battery pack. In FIG. 9C, the two lithium-ion battery packs are placed in series with a proper amount of distance therebetween. In FIG. 9C, the two lithium-ion battery packs are positioned such that the battery pack terminals of one of the two lithium-ion battery packs are positioned next to the bottom of the other lithium-ion battery pack.

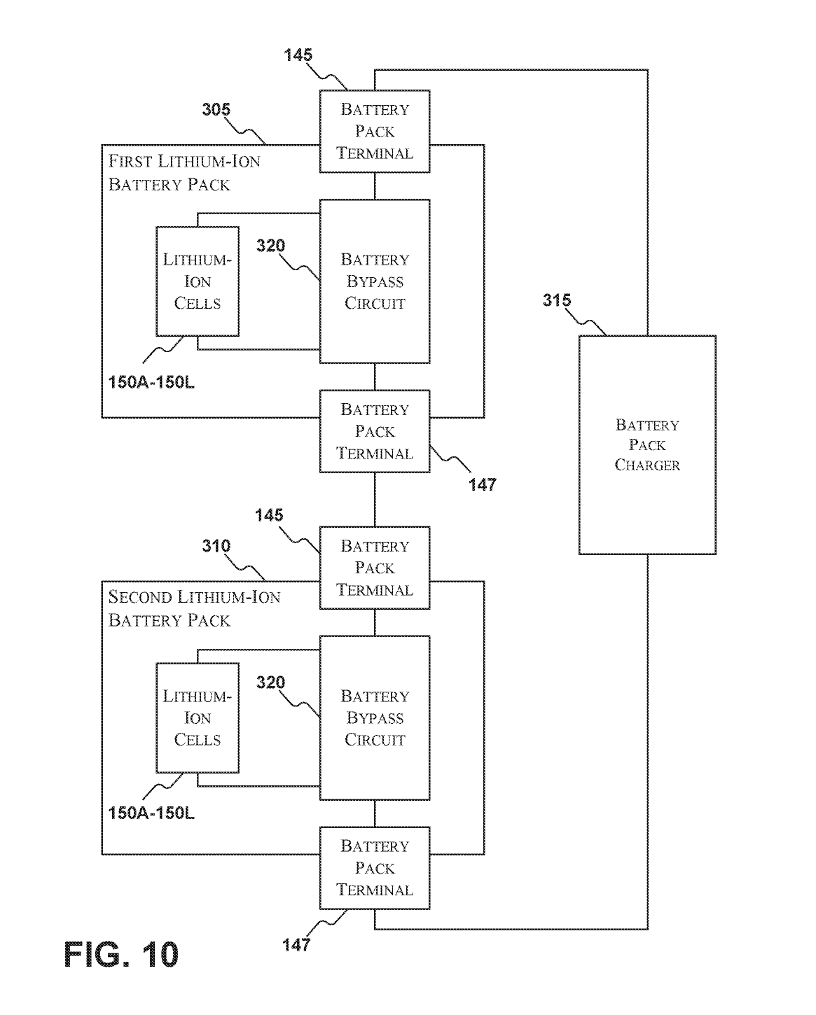

FIG. 10 illustrates a first lithium-ion battery pack 305, a second lithium-ion battery pack 310, and a battery pack charger 315 connected in series with each other. In some embodiments, the lithium-ion battery pack 100 includes a battery bypass circuit 320. The battery bypass circuit 320 is coupled to the first battery pack terminal 145 and to the second battery pack terminal 147, as illustrated in FIG. 10. The battery bypass circuit 320 selectively allows current to flow directly between the first battery pack terminal 145 and the second battery pack terminal 147. For example, the battery bypass circuit 320 bypasses the cells 150A through 150L in the first lithium-ion battery pack 305 when they are fully charged to enable charging of the cells 150A through 150L in the second lithium-ion battery pack 310.

Various features and advantages of the lithium-ion battery pack are set forth in the following claims.

What is claimed is:

1. A lithium-ion battery pack comprising:
a housing, the housing including a top, a base, a first sidewall, and a second sidewall opposite the first sidewall;
a first battery pack terminal;
a second battery pack terminal;
a control circuit within the housing, the control circuit including a printed circuit board having a longitudinal axis;
a plurality of lithium-ion cells within the housing, the plurality of lithium-ion cells each having two cell terminals and a longitudinal axis positioned parallel with the longitudinal axis of the printed circuit board, the plurality of lithium-ion cells all arranged in at least a first cell stack and a second cell stack;
a first bus bar extending substantially from the base to the top, the first bus bar electrically coupling the printed circuit board to cell terminals of the first cell stack, wherein the cell terminals of the first cell stack are adjacent to the first sidewall;
a second bus bar extending substantially from the base to the top, the second bus bar electrically coupling the printed circuit board to cell terminals of the second cell stack, wherein the cell terminals of the second cell stack are adjacent to the first sidewall; and
an interconnect plate electrically coupling the cell terminals of the plurality of lithium-ion cells positioned adjacent to the second sidewall.

2. A lithium-ion battery pack comprising:
a housing;
a first battery pack terminal;
a second battery pack terminal;
a control circuit within the housing, the control circuit including a printed circuit board having a longitudinal axis;
an interconnect plate including
a bend between a first end and a second end of the interconnect plate,
a first welding point on the first end of the interconnect plate, and
a second welding point on the second end of the interconnect plate; and
a first lithium-ion cell coupled to the first welding point and to the first battery pack terminal; and
a second lithium-ion cell coupled to the second welding point and to the second battery pack terminal,
wherein each of the first lithium-ion cell and the second lithium-ion cell have a longitudinal axis positioned parallel with the longitudinal axis of the printed circuit board.

3. The lithium-ion battery pack according to claim 2, wherein the interconnect plate includes a prong electrically coupled to the printed circuit board.

4. The lithium-ion battery pack according to claim 2, wherein the first welding point and the second welding point are positioned opposite from each other.

5. A lithium-ion battery pack comprising:
a housing, the housing including a top, a base, a first sidewall, a second sidewall, a third sidewall, a fourth sidewall, and a plurality of vents, wherein a first distance between the top and the base is approximately 94 millimeters, a second distance between the first sidewall and the second sidewall is approximately 150 millimeters, a third distance between the third sidewall and the fourth sidewall is approximately 65 millimeters, and wherein the plurality of vents constitute at least five percent of a surface area of the housing;
a first battery pack terminal;
a second battery pack terminal;
a control circuit within the housing; and
a plurality of lithium-ion cells within the housing, the plurality of lithium-ion cells electrically coupled to the first battery pack terminal and to the second battery pack terminal.

6. A lithium-ion battery pack comprising:
a housing defining an interior space;
a first battery pack terminal;
a second battery pack terminal;
a control circuit within the housing, the control circuit including a printed circuit board;
a plurality of lithium-ion cells within the housing; and
an externally exposed heat sink thermally coupled to the interior space.

7. The lithium-ion battery pack according to claim 6, further comprising an internal heat sink within the interior space.

8. The lithium-ion battery pack according to claim 7, further comprising an isolator layer thermally coupling the internal heat sink to the externally exposed heat sink, the isolator layer being electrically isolating.

9. The lithium-ion battery pack according to claim 6, wherein the externally exposed heat sink includes a plurality of fins extending at an angle relative to a remainder of the externally exposed heat sink.

10. A lithium-ion battery pack comprising:
a housing;
a first battery pack terminal;
a second battery pack terminal;
a control circuit within the housing;
a plurality of lithium-ion cells within the housing; and
a bus bar electrically coupling the plurality of lithium-ion cells to the control circuit, the bus bar including
a first metal layer, the first metal layer including a plurality of welding points for connection to cell terminals of the plurality of lithium-ion cells, the first metal layer composed substantially of nickel, and
a second metal layer coupled to the first metal layer, the second metal layer composed of a high conductivity metal other than nickel.

11. The lithium-ion battery pack according to claim 10, wherein the second metal layer includes a plurality of apertures positioned adjacent to the plurality of welding points.

12. The lithium-ion battery pack according to claim 10, wherein the second metal layer is composed of at least one metal selected from a group consisting of copper and aluminum.

13. The lithium-ion battery pack according to claim 10, wherein the second metal layer is welded to the first metal layer.

14. The lithium-ion battery pack according to claim 10, wherein the second metal layer includes a layer of nickel deposited on the high conductivity metal.

15. A lithium-ion battery pack comprising:
a housing;
a first battery pack terminal;
a second battery pack terminal;
a plurality of lithium-ion cells within the housing; and
a control circuit within the housing, the control circuit including a battery bypass circuit configured to selectively allow electrical current to flow directly between the first battery pack terminal and the second battery pack terminal.

16. A lithium-ion battery pack comprising:
a housing, the housing including a top;
a first battery pack terminal;
a second battery pack terminal;
a plurality of lithium-ion cells within the housing, the plurality of lithium-ion cells each having a longitudinal axis positioned parallel with the top, the plurality of lithium-ion cells all arranged in at least a first cell stack, the first cell stack including a first lithium-ion cell and a second lithium-ion cell; and
a bus bar including
a first metal layer having
a first welding point coupled to a first cell terminal of the first lithium-ion cell, and
a second welding point coupled to a first cell terminal of the second lithium-ion cell,
wherein the first metal layer is electrically coupled to the first battery pack terminal, and
a second metal layer composed of a metal different than the first metal layer and having
a first aperture positioned adjacent to the first welding point, and
a second aperture positioned adjacent to the second welding point.

17. The lithium-ion battery pack according to claim 16, wherein the second metal layer is thicker than the first metal layer.

18. The lithium-ion battery pack according to claim 16, wherein the first metal layer is composed substantially of nickel, and wherein the second metal layer is composed of at least one metal selected from a group consisting of copper and aluminum.

19. The lithium-ion battery pack according to claim 16, wherein the lithium-ion battery pack further comprises an interconnect plate, wherein each of the first lithium-ion cell and the second lithium-ion cell has a second cell terminal coupled to the interconnect plate.

20. The lithium-ion battery pack according to claim 19, wherein the interconnect plate includes a bend.

21. The lithium-ion battery pack according to claim 19, wherein the lithium-ion battery pack further comprising a control circuit, and wherein the interconnect plate includes a prong coupled to the control circuit.

22. The lithium-ion battery pack according to claim 19, wherein the plurality of lithium-ion cells are further arranged in a second cell stack, and wherein each lithium-ion cell within the second cell stack has a first cell terminal coupled to the interconnect plate.

23. The lithium-ion battery pack according to claim 22, wherein the interconnect plate is a first interconnect plate, wherein the lithium-ion battery pack further comprises a second interconnect plate, and wherein each lithium-ion cell within the second cell stack has a second cell terminal coupled to the second interconnect plate.

24. The lithium-ion battery pack according to claim 23, wherein the first interconnect plate includes a bend, and wherein the second interconnect plate is substantially flat.

25. The lithium-ion battery pack according to claim 23, wherein the plurality of lithium-ion cells are further arranged in a third cell stack, and wherein each lithium-ion cell within the third cell stack has a first cell terminal coupled to the second interconnect plate.

26. The lithium-ion battery pack according to claim 25, wherein the lithium-ion battery pack further comprises a third interconnect plate, wherein each lithium-ion cell within the third cell stack has a second cell terminal coupled to the third interconnect plate.

27. The lithium-ion battery pack according to claim 26, wherein each of the first and third interconnect plates includes a first bend, and wherein the second interconnect plate is substantially flat.

28. The lithium-ion battery pack according to claim 26, wherein the plurality of lithium-ion cells are further arranged in a fourth cell stack, and wherein each lithium-ion cell within the fourth cell stack has a first cell terminal coupled to the third interconnect plate.

29. The lithium-ion battery pack according to claim 28, wherein the bus bar is a first bus bar, wherein the lithium-ion battery pack further comprises a second bus bar, wherein each lithium-ion cell within the fourth cell stack has a second cell terminal coupled to the second bus bar, and wherein the second bus bar is electrically coupled to the second battery pack terminal.

30. A lithium-ion battery pack comprising:
a housing, the housing including a top and a base;
a first battery pack terminal partially within the housing;
a second battery pack terminal partially within the housing;
a control circuit within the housing;
a plurality of lithium-ion cells within the housing, the plurality of lithium-ion cells electrically coupled to the first battery pack terminal and to the second battery pack terminal; and
a spacer projecting from either the top or the base, the spacer having a stepped structure adapted to engage at least one selected from a group consisting of another battery pack housing, a recess in another battery pack housing, and another spacer.

31. The lithium-ion battery pack according to claim 30, wherein the spacer includes a first level extending from the housing.

32. The lithium-ion battery pack according to claim 31, wherein the spacer further includes two projections extending further from the housing than the first level.

33. The lithium-ion battery pack according to claim 30, wherein the spacer is molded into the housing.
